(19) United States
(12) Patent Application Publication
(10) Pub. No.: US 2024/0149731 A1
(43) Pub. Date: May 9, 2024

(54) METHOD AND APPARATUS FOR OPTIMAL CHARGING AT CHARGING STATION HAVING A COOLING SYSTEM

(71) Applicant: Volvo Car Corporation, Göteborg (SE)

(72) Inventors: Andreas Ropel, Göteborg (SE); Ben Lloyd, Göteborg (SE); Mathias Le Saux, Göteborg (SE); Kostas Chatziioannou, Göteborg (SE); Klas Persson Signell, Göteborg (SE)

(21) Appl. No.: 17/981,920

(22) Filed: Nov. 7, 2022

(51) Int. Cl. B60L 53/62; B60L 53/10; B60L 53/66; B60L 58/16; B60L 58/26

(52) U.S. Cl. CPC B60L 53/62; B60L 53/11; B60L 53/66; B60L 58/16; B60L 58/26

(57) ABSTRACT

A system and method comprising a charging station and a temperature management system, wherein the charging station and the temperature management system coordinate with each other to extract a state-of-health information of a connected charging system, to determine an optimal charging scheme based on allotted time and required charge to optimally charge the connected charging system, to ramp up charging of the connected charging system by the charging station for the allotted time, to monitor temperature of battery pack of the connected charging system, to predict the temperature of battery pack of the connected charging system during a ramp up charging and to activate the temperature adjustment unit that cools the connected charging system, when the temperature is above a threshold temperature during the ramp up charging.

### FIELD OF THE INVENTION

An embodiment relates generally to optimal charging so that the battery pack of the electric vehicle does not get damaged, and the maximum charge current is adjusted according to the state of the battery. The invention is more particularly related to a method and system for optimally charging at a charging station having a temperature management system, specifically a cooling system.

### BACKGROUND

A battery drives electric vehicles. The problem is that maximizing charging of a battery during a short, allotted time period, requires a fast charging scheme. The problem is that when using the fast charging scheme, the battery may overheat, thereby causing damage to one or more cells. Thus, there is a requirement for a system to cool the battery if the temperature reaches a threshold during a fast charge (e.g., predetermined optimal charging scheme).

Therefore, there is a long-felt need for providing an efficient method and system for the charging station with a temperature management system which can ramp-up charging based on the instructions provided by the user.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

Accordingly, the present disclosure describes one or more aspects of a system comprising a charging station comprising a control unit; and a temperature management system; wherein the temperature management system comprises a temperature prediction unit and a temperature adjustment unit; wherein the charging station and the temperature management system coordinate with each other: to extract a state-of-health information of a connected charging system; to determine an optimal charging scheme based on allotted time and first charging voltage to optimally charge the connected charging system; to ramp up charging of the connected charging system by the charging station for a first charging time; to monitor temperature of a battery pack of the connected charging system; to predict the temperature of the battery pack of the connected charging system of the optimal charging scheme; and to activate the temperature adjustment unit when the temperature of the battery pack is above a threshold temperature during the ramp up charging; and wherein the temperature adjustment unit cools the connected charging system.

An embodiment relates to a method comprising: extracting, by a charging station comprising a control unit, a state-of-health information of a connected charging system; determining, by a charging station, based on a first charging time and first charging voltage, a an optimal charging scheme to optimally charge the connected charging system; ramping up charging of the connected charging system by the charging station for the first charging time; monitoring, by temperature prediction unit, the temperature of battery pack of the connected charging system; predicting, by temperature prediction unit, the temperature of the battery pack of the connected charging system of the optimal charging scheme; and activating, a temperature adjustment unit, when the temperature of the battery pack of the connected charging system is above a threshold temperature during the ramping up of charging; and wherein a temperature management system comprises the temperature prediction unit and the temperature adjustment unit; wherein the temperature adjustment unit comprises a cooling system; wherein the first charging time is allotted by a user; and wherein the temperature adjustment unit cools the connected charging system.

An embodiment relates to a non-transitory computer readable medium storing a sequence of instructions comprising: receiving state-of-health information from a connected charging system; comparing the state-of-health information with optimal parameters to generate a comparative report and instructions; determining an optimal charging scheme based on first charging time, the comparative report and a first charging voltage to optimally charge the connected charging system; ramping up charging of the connected charging system; giving the instructions to a charging station, the connected charging system and a temperature management system, when temperature is above or below a threshold temperature while ramping up charging; and storing charging data of the connected charging system; wherein the temperature management system comprises a temperature prediction unit and a temperature adjustment unit; wherein the temperature adjustment unit comprises a cooling system and wherein the non-transitory computer readable medium is a component of the charging station.

An embodiment relates to a device comprising an application configured to: extract location of a user; extract waiting time of the user at the location; send an information of the user to a charging station; receive the information from the charging station; wherein the user and the charging station, each, comprise the application.

An embodiment relates to a system comprising: set of instructions executable by a computing hardware and stored in a non-transitory storage medium that, when executed, cause the computing hardware to implement operations comprising, to extract a state-of-health information of a connected charging system; to determine an optimal charging scheme based on an allotted time and a first charging voltage to optimally charge the connected charging system; to ramp up charging of the connected charging system by the charging station for a first charging time; to monitor temperature of a battery pack of the connected charging system; to predict the temperature of the battery pack of the connected charging system of the optimal charging scheme; and to activate the temperature adjustment unit when the temperature of the battery pack is above a threshold temperature during the ramp up charging; and wherein the temperature adjustment unit cools the connected charging system; and wherein the system is configured for a software application to be installed, via a software installation package provided over a computer network, onto the computing hardware associated with the vehicle.

An embodiment relates to a system comprising a charging station comprising a control unit; and a temperature management system; wherein the temperature management system comprises a temperature prediction unit and a temperature adjustment unit; wherein the charging station and the temperature management system coordinate with each other: to extract a state-of-health information of a connected charging system; to determine an optimal charging scheme based on allotted time and first charging voltage to optimally charge the connected charging system; to ramp up charging of the connected charging system by the charging station for a first charging time; to monitor temperature of a battery pack of the connected charging system; and to activate the temperature adjustment unit when the temperature of the battery pack is above a threshold temperature during the ramp up charging; and wherein the temperature adjustment unit cools the connected charging system.

An embodiment relates to a method comprising extracting, by a charging station comprising a control unit, a state-of-health information of a connected charging system; determining, by a charging station based on first charging time and first charging voltage, an optimal charging scheme to optimally charge the connected charging system; ramping up charging of the connected charging system by the charging station for the first charging time; monitoring, by temperature prediction unit temperature of battery pack of the connected charging system; activating, the temperature adjustment unit, when the temperature of the battery pack of the connected charging system is above a threshold temperature during the ramping up of charging; and wherein the temperature management system comprises temperature prediction unit and temperature adjustment unit; wherein the temperature adjustment unit comprises a cooling system; wherein the first charging time is allotted by a user; and wherein the temperature adjustment unit cools the connected charging system.

An embodiment relates to a system, comprising: set of instructions executable by a computing hardware and stored in a non-transitory storage medium that, when executed, cause the computing hardware to implement operations comprising, to extract a state-of-health information of a connected charging system; to determine an optimal charging scheme based on allotted time and first charging voltage to optimally charge the connected charging system; to ramp up charging of the connected charging system by the charging station for a first charging time; to monitor temperature of a battery pack of the connected charging system; and to activate the temperature adjustment unit when the temperature of the battery pack is above a threshold temperature during the ramp up charging; and wherein the temperature adjustment unit cools the connected charging system; and wherein the system is configured for a software application to be installed, via a software installation package provided over a computer network, onto the computing hardware associated with the vehicle.

An embodiment relates to a system comprising a charging station comprising a temperature control system comprises a cooling system capable of cooling a connected battery; wherein the cooling system is configured with cooling fans or devices that are configured to blow cool air.

### BRIEF DESCRIPTION OF THE FIGURES

In the present disclosure, reference is made to the accompanying drawings, which form a part hereof. In the drawings, similar symbols typically identify similar components, unless context dictates otherwise. Various embodiments described in the detailed description, and drawings, are illustrative and not meant to be limiting. Other embodiments may be used, and other changes may be made, without departing from the spirit or scope of the subject matter presented herein. It will be understood that the aspects of the present disclosure, as generally described herein, and illustrated in the figures, can be arranged, substituted, combined, separated, and designed in a wide variety of different configurations, all of which are contemplated herein. The embodiments are illustrated by way of example and not limitation in the figures of the accompanying drawings, in which like references indicate similar elements.

These and other aspects of the present invention will now be described in more detail, with reference to the appended drawings showing exemplary embodiments of the present invention, in which:

FIG. 1A depicts a block diagram of a system for optimal charging the charging system in one or more embodiments.

FIG. 1B depicts a block diagram of a system for optimal charging the charging system in another embodiment.

FIG. 2A shows the cooling system in a block.

FIG. 2B shows the heating system in a block.

FIG. 3A shows a flowchart depicting a method to optimally charge a connected charging system by the charging station including the temperature management system according to one embodiment.

FIG. 3B shows a flowchart depicting a method to optimally charge a connected charging system by the charging station including the temperature management system according to another embodiment.

FIG. 4 shows an embodiment of providing instructions to the charging station by the user.

FIG. 5 shows an embodiment of alteration in the charging scheme.

FIG. 6. illustrates a battery pack comprising an individual battery, according to one or more embodiments.

FIG. 7 illustrates a battery pack comprising a plurality of batteries, according to one or more embodiments

FIG. 8 schematically shows a battery pack comprising a battery and a battery management system, according to one or more embodiments.

FIG. 9 shows an example of message content received by the charging station, according to one embodiment.

FIG. 10 shows an example of message content received by the charging station, according to one embodiment.

FIG. 11A shows a structure of the neural network/machine learning model with a feedback loop.

FIG. 11B shows a structure of the neural network/machine learning model with reinforcement learning.

FIG. 12A shows steps executed by a computer readable medium storing a sequence of instructions for optimally charging the connected charging system according to one embodiment.

FIG. 12B shows steps executed for installation of instructions in a vehicle computing hardware for optimally charging the connected charging system according to an embodiment.

FIG. 12C shows steps executed for installation of instructions in a vehicle computing hardware for optimally charging the connected charging system according to another embodiment.

FIG. 13 shows device comprising an application according to one embodiment.

FIG. 14 shows system comprising charging station and other components according to one embodiment.

Other features of the present embodiments will be apparent from the accompanying drawings and from the detailed descriptions that follow.

### DETAILED DESCRIPTION

### Definitions and General Techniques

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same elements.

Although the herein detailed description contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

The terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” and “have,” and any variations thereof, cover a non-exclusive inclusion, such that a process, method, system, article, device, or apparatus that comprises a list of elements is not necessarily limited to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

As used herein, the term “component” broadly construes hardware, firmware, and/or a combination of hardware and software.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting of the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or as a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or be operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e. g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback provided to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments of the present invention may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments, it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit)) may embody the various electrical structures and methods.

In addition, a non-transitory machine-readable medium and/or a system may embody the various operations, processes, and methods disclosed herein. Accordingly, the specification and drawings are illustrative rather than a restrictive sense.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code means in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the following claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The disclosure provides illustration and description but is not intended to be exhaustive or to limit the implementations to the precise form disclosed. Modifications and variations are possible in light of the above disclosure or may be acquired from practice of the implementations.

The following terms and phrases, unless otherwise indicated, shall be understood to have the following meanings.

As referred herein, an “autonomous vehicle” is a vehicle that is capable of sensing its environment and moving safely with little or no human input. An autonomous vehicle may operate in a mode selected from among an autonomous mode, a manual mode, and a remote-control mode. In an example, the autonomous mode indicates operation without control of a driver, the manual mode indicates operation in accordance with a control input of the driver, and the remote-control mode indicates remotely controlled operation by an external device.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As referred herein, “processor” refers to a device that interprets and executes instructions, comprising at least an instruction control unit and an arithmetic unit that contains a central processing unit.

The term “vehicle” as used herein refers to a thing used for transporting people or goods. Automobiles, cars, trucks, buses etc., are examples of vehicles.

The term “electric vehicle (EV)” as used herein refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads.

The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

The term “plug-in electric vehicle (PEV)” as used herein refers to an Electric Vehicle that recharges the on-vehicle primary battery by connecting to the power grid.

The term “plug-in vehicle (PV)” as used herein refers to an electric vehicle rechargeable through wireless charging from an electric vehicle supply equipment (EVSE) without using a physical plug or a physical socket.

The term “heavy duty vehicle (HD Vehicle)” as used herein refers to any four- or more wheeled vehicle as defined in 49 CFR 523.6 or 49 CFR 37.3 (bus).

The term “light duty plug-in electric vehicle” as used herein refers to a three or four-wheeled vehicle propelled by an electric motor drawing current from a rechargeable storage battery or other energy devices for use primarily on public streets, roads and highways and rated at less than 4, 545 kg gross vehicle weight.

The term “level 1 charging” refers to a charge that uses 120 volts-208 volts. Every electric vehicle or plug-in hybrid can be charged on level 1 charging by plugging the charging equipment into a regular wall outlet. Level 1 charging may be the slowest way to charge an EV. Level 1 charging, generally adds between 3 and 5 miles of range per hour.

The term “level 2 charging” refers to a charging that uses 208 volts-240 volts (or volt range). Level 2 charging is the most commonly used for daily EV charging. Level 2 charging equipment can be installed at home, at the workplace, as well as in public locations like shopping plazas, train stations and other destinations. Level 2 charging can replenish between 12 and 80 miles of range per hour, depending on the power output of the Level 2 charger, and the vehicle's maximum charge rate.

The term “level 3 charging” refers to a charging that uses 400 Volts to 900 Volts DC. Level 3 charging is the fastest type of charging available and can recharge the EV at a rate of 3 to 20 miles of range per minute. Unlike Level 1 charging and Level 2 charging that uses alternating current (AC), Level 3 charging uses direct current (DC).

As used herein “Machine learning” refers to algorithms that give a computer the ability to learn without explicit programming including algorithms that learn from and make predictions about data. Machine learning algorithms include, but are not limited to, decision tree learning, artificial neural networks (ANN) (also referred to herein as a “neural net”), deep learning neural network, support vector machines, rule-based machine learning, random forest, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the AI/ML model improving the model's accuracy and performance over time.

Statistical modeling relies on finding relationships between variables (e.g., mathematical equations) to predict an outcome.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that measures physical input from its environment and converts it into data that is interpretable by either a human or a machine. Most sensors are electronic, which presents electronic data, but some are simpler, such as a glass thermometer, which presents visual data.

The term “autonomous mode” as used herein refers to an operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner.

The term “autonomous vehicle or autonomous car” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio detection and Ranging (radar), Light detection and Ranging (lidar), Sound Navigation and Ranging (sonar), Global Positioning System (GPS), odometry and inertial measurement unit. Control systems designed for the purpose, interpret sensor information to identify appropriate navigation paths, as well as obstacles and relevant signage.

The term “energy source” as used herein refers to the electrical and mechanical equipment and their interconnections necessary to generate or convert power.

The term “AC” as used herein refers to alternating current.

The term “DC” as used herein refers to direct current.

The term “wired connection” as used herein refers to a connection using physical cables to connect between the devices.

The term “wireless connection” as used herein refers to electrical connection between two or more points that do not use an electrical conductor as a medium.

The term “power grid” as used herein refers to a network, usually of a power company, for transmitting and distributing electric power.

The term “circuit” as used herein refers to an arrangement of interconnected components that has at least one input and one output terminal, and whose purpose is to produce at the output terminals a signal that is a function of the signal at the input terminals.

The term “component” as used herein refers to a part or element of a larger whole, especially a part of a machine, a circuit, or a vehicle.

As used herein “temperature management system (TMS)” is a system that is used to monitor and control temperature of the battery pack with a range i.e. threshold, to assure health of battery cells. Temperature management system comprises temperature prediction unit and temperature adjustment unit. Threshold is defined here as that limit of temperature above and below which the charging or discharging efficiency starts to degrade.

The term “degraded cells” as used herein refers to energy storage cells where the physical and chemical changes have occurred. The degraded cells can store or deliver energy less than the actual capacity.

The term “healthy cells” as used herein refers to energy storage cells which can store or deliver energy equal to the actual capacity.

The term “moderate degraded cells” as used herein refers to energy storage cells which store or deliver energy less than the actual capacity but equal to a threshold capacity.

The term “control unit” or “control module” or “electronic control unit” refers to a functional unit in a computer system that controls one or more units of the peripheral equipment. For example it may be a component of a charging station that provides instructions or signals to the charger unit to charge the battery pack as per the charging requirement.

The term “battery pack” as used herein refers to a set of any number of identical batteries or individual cells of a battery. The “battery pack” may also refer to a set of non-identical batteries. The batteries in the battery pack may be configured in a series, parallel or a mixture of both to deliver the desired voltage, capacity, and/or power density.

The term “charging station” as used herein refers to a device or apparatus that includes at least one docking terminal with a charger for charging a battery pack. The term “charging station” as used further refers to an apparatus that can function as a source of power for charging the battery pack of an electric vehicle including facilitating data communications between the electric vehicle and the charging station. The communications may be established through a wired connection or a wireless connection. The charging station is also capable of charging the electric vehicle either through a wired connection or a wireless connection.

The term “charging system” as used herein refers to an apparatus that is capable of charging a battery pack. The charging system is capable of monitoring and controlling the battery pack. The charging system is also capable of calculating and monitoring battery parameters (e.g., battery impedance, battery resistance, battery temperature, state-of-charge, state-of-health, etc.). The charging system is communicatively coupled to a vehicle computer system. The charging system is also communicatively coupled to the charging station.

The term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc. that are executed on separate control units. The vehicle computer system may be communicatively coupled with an external device of a user. The vehicle computer system may also be communicatively coupled with the charging station.

The term “electronic control unit” (ECU), also known as an “electronic control module” (ECM), is a system that controls one or more subsystems. An ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be embedded system in automotive electronics. In another example, the electronic control unit is wirelessly coupled with the automotive electronics.

The term “infotainment system” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “charging sequence or scheme” as used refers to a charging pattern defined by the charging system or the charging station based on the battery parameters (e.g., state-of-health) and charging time. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

The term “maximum charging” or “optimally charging” as used refers to a maximum rate at which charging station provides the charging to the battery pack during the charging time without damaging the battery pack.

The term “charging time” as used herein refers to a time allotted for charging. The charging time may be provided by the user. The charging time may also be determined by the charging station or the charging system. The charging time may be split into charging time segments. Each charging time segment may correspond to a different charging level. Each charging time segment may correspond to charging different portions of the battery pack.

The term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. It is expressed in percentage form.

The term “trickle charging” refers to charging a battery pack continuously or periodically with a very small current. The trickle charge also refers to a continuous, slow charge applied to the battery pack.

The term “fast charging” refers to charging a battery pack faster than regular charging.

The term “regular charging” refers to charging a battery pack by supplying a standard charging voltage employed according to the capacity of the battery pack.

The term “communication” as used herein refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units.

The term “communication system” or “communication module” as used herein refers to a system which enables the information exchange between two points. The process of transmission and reception of information is called communication. The major elements of communication include but are not limited to a transmitter of information, channel or medium of communication and a receiver of information.

The term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “cooling system” as used herein refers to a part of the temperature management system and more precisely of a temperature adjustment unit that helps to lower the temperature of the battery pack. The cooling system may include a chiller assembly that includes a compressor, a condenser, an expansion valve, an evaporator and a fan. During operation of the cooling system, the compressor pressurizes and circulates a coolant of the cooling system. The cooling system may also comprise a fan or a cold air blower.

The term “heating system” as used herein refers to a part of the temperature management system and more precisely of a temperature adjustment unit that helps to increase the temperature of the battery pack. The use of a heating system generally happens if charging is needed before or just soon after the start of the vehicle. The heating system may include a hot air blower or heaters.

The term “artificial intelligence (AI)” as used herein refers to the intelligence demonstrated by machines, as opposed to the natural intelligence displayed by humans. AI research has been defined as any system that perceives its environment and takes actions that maximize its chance of achieving its goals. The term “artificial intelligence” is now described in terms of rationality and acting rationally, which does not limit how intelligence can be articulated.

The term “battery management system (BMS)” used herein refers to a system that is used to monitor and control power storage systems, assure health of battery cells, and deliver power to vehicle systems. Isolation products have numerous uses inside BMS in the electrical domains of Electric Vehicles (EV) or Hybrid Electric Vehicles (HEV).

The term “bidirectional communication” as used herein refers to an exchange of data between two components. In an example, the first component can be a vehicle and the second component can be an infrastructure that is enabled by a system of hardware, software, and firmware. This communication is typically wireless. In another example, the first component can be a charging system and the second component can be a charging station.

As used herein “Machine learning” refers to algorithms that give a computer the ability to learn without being explicitly programmed, including algorithms that learn from and make predictions about data. Machine learning algorithms include, but are not limited to, decision tree learning, artificial neural networks (ANN) (also referred to herein as a “neural net”), deep learning neural network, support vector machines, rules-based machine learning, random forest, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. Statistical modeling relies on finding relationships between variables (e.g., mathematical equations) to predict an outcome. The ANN may be featured with a feedback loop to adjust the system output dynamically as it learns from the new data as it becomes available. In machine learning, backpropagation and feedback loops are used to train the AI/ML model improving the model's accuracy and performance over time.

The problem is that when maximizing charging of a battery during a short allotted time period, a fast charging scheme is required. The problem is that when using the fast charging scheme, the battery may overheat, thereby causing damage to one or more cells. Thus, battery needs the cooling system to cool the battery if the temperature reaches or exceeds a threshold temperature during a fast charge (e.g., predetermined optimal charging scheme).

In an aspect, the charging station comprises a temperature control environment that is capable of cooling a connected battery. For example, the charging station configured with cooling fans or devices that can blow cold air (e.g., extreme cool temperatures) are provided, for example, under the parked car. The optimal charging system receives allotted time to charge, establishes connection with the vehicle to extract additional information, such as state-of-health of battery pack/s and other vital information of the battery (e.g., temperature, impact of charging at current temperatures, etc.). The system uses various information to optimally charge the battery while connected and for the allotted time, including controlling the temperature of the battery using one or more cooling systems. In an aspect, the system determines the optimal charging scheme based on allotted time and required charge to optimally charge the battery or cells (e.g., fully charge each cell). The system monitors the temperature of the battery pack/s. If the temperature reaches a threshold temperature or impacts the charging, the system may activate the cooling system to lower the temperature of the battery and thereby continue charging using the optimal charging scheme without any alteration. In an aspect, if the cooling system is not effective due to external conditions, the system will alter the optimal charging scheme to prevent damage to the battery pack/s or the battery cells within the battery pack/s.

In an embodiment, the temperature adjustment unit comprises a cooling system.

In another embodiment, the cooling system comprises a cooling fan, a cold air blower.

In an embodiment, the temperature adjustment unit comprises a heating system.

In an embodiment, the charging station and the temperature management system coordinate with each other to activate the heating system that is capable of heating the connected charging system if the charging system battery pack temperature is below a threshold temperature during the ramp up charging.

In an embodiment, the charging station comprises the temperature management system.

In an embodiment, the system is further configured to alter a charging scheme if the temperature does not go down below a set threshold temperature to prevent damage to the battery pack.

In an embodiment, the charging scheme comprises a charging time, charging voltage, or voltage intervals; wherein a user defines the charging scheme.

In an embodiment, the charging station further comprises a transformer configured to step up and to step down voltage.

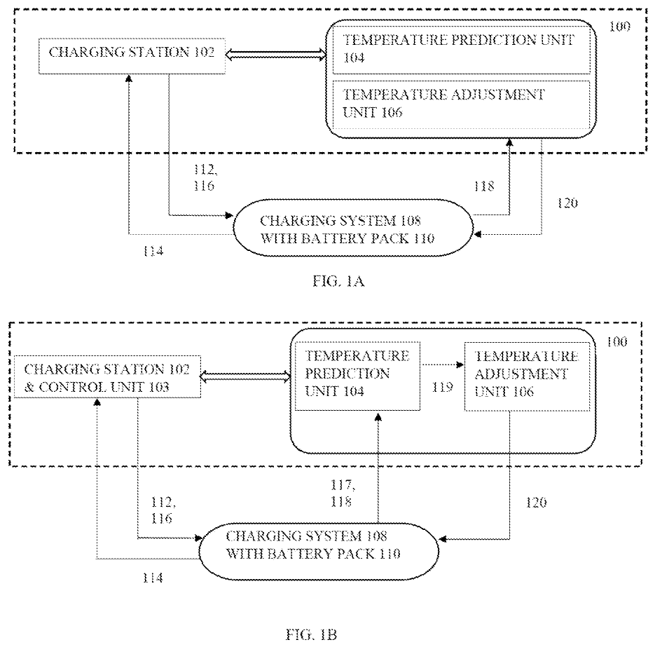

As an example, FIG. 1A depicts a block diagram of a system for optimal charging the charging system in one or more embodiments. The system comprises a charging station 102, and a temperature management system comprising a temperature prediction unit 104 and a temperature adjustment unit 106. The charging station 102 is configured to charge the charging system 108. The system may further comprise a two-way communication circuit that enables two-way communication between components of the system. The charging system provides the state-of-health (SoH) information 114 to the control unit of the charging station 102 and similarly provides the temperature of the battery pack information 118 to the temperature prediction unit 104 and then the temperature adjustment unit 106 controls the temperature of the battery pack by a channel 120. Similarly, the charging station after receiving SoH information 114 from the charging system provides an optimal charging scheme and provides a first voltage 112 for a predefined or allotted time by the user. However, if the charging station determines, or the charging system notifies the charging station, that there is damage (potential damage) to the battery pack at the first voltage, then the charging station provides a second voltage 116, which is lower than the first voltage 112, for the same allotted time to prevent (further) damage to the battery pack.

As another example, FIG. 1B depicts a block diagram of a system for optimal charging the charging system in another embodiment. The system comprises a charging station 102 comprising a control unit 103 and a temperature management system comprising a temperature prediction unit 104 and a temperature adjustment unit 106. The charging station 102 is configured to charge the charging system 108. The system may further comprise a two-way communication circuit that enables two-way communication between components of the system. The charging system provides the state-of-health (SoH) information 114 to the control unit 103 of the charging station 102. Temperature prediction unit 104 predict the temperature of the battery pack 117 of the connected charging system of the optimal charging scheme and also provides the temperature of the battery pack information 118. Temperature prediction unit 104 then sends information to the temperature adjustment unit 106 to control the temperature of the battery pack by a channel 120. Similarly, the charging station after receiving SoH information 114 from the charging system provides an optimal charging scheme and provides a first voltage 112 for a predefined or allotted time by the user. However, if the charging station determines, or the charging system notifies the charging station, that there is damage (potential damage) to the battery pack at the first voltage, then the charging station provides a second voltage 116, which is lower than the first voltage 112, for the same allotted time to prevent (further) damage to the battery pack.

In an embodiment, the electric vehicle which comprises the charging system 108 described herein may operate in an autonomous mode or a self-driving mode. The electric vehicle comprises a charging system, a battery pack, and a vehicle computer system. In an embodiment, the battery pack comprises an individual battery comprising a plurality of cells. In another embodiment, the battery pack comprises at least one of a first battery (e.g., primary battery), a second battery (e.g., secondary battery), and a third battery (e.g., tertiary battery). The primary battery may be a predominant battery supplying power to the electric motor and other components intended for driving the electric vehicle. The secondary battery and the tertiary battery may be adapted for supplying power to other components of the EV (e.g., infotainment system, lighting, etc.). Each battery of the battery pack comprises cells. The charging station 102 may electrically connect each battery of the battery pack with one another to get charged. In an embodiment, the charging station 102 charges each battery of the battery pack in a random manner (e.g., round robin manner). In another embodiment, the charging station 102 charges each battery of the battery pack in a sequential order. In yet another embodiment, the charging station 102 charges each battery of the battery pack at the same time, in parallel.

The vehicle computer system comprises an infotainment system and/or an automotive head unit. The vehicle computer system comprises a user interface (e.g. graphical user interface) that enables a user to interact with the system. In an embodiment, the vehicle computer system enables the user to interact and control the system through a voice input.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a determining a charging sequence, the messages in queue for displaying could be a charging sequence, a charging time segment, a charging level type, a modified charging sequence, amount of power, establishment of communication link, etc. In all these messages that need a user's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user that a charging sequence determined may be of higher priority as compared to intimating establishment of communication link. Therefore, the charging sequence takes priority and takes such a place on the display (example, center of the display) which can grab the users' attention immediately. The priority of the messages is evaluated dynamically as the situation is evolving and thus the display icons, positions, and sizes of the text or icon on the display are changed in real time and dynamically. In an embodiment, more than one message is displayed and highlighted as per the situation and the user's actions. Further, while charging, if the charging time is updated for example, a modified charging sequence is determined, the message dynamically changes and intimates the user about the modified charging sequence.

In another embodiment, the user is also able to provide instructions to the system or charging station by speaking, as the charging station may be configured with natural language processing. In another embodiment, the vehicle computer system enables the user to interact and control the system through a text input. The vehicle computer system is a component providing a unified hardware interface for the system, including touch screens, display screens, buttons and system controls for numerous integrated information and entertainment functions. The vehicle computer system is configured to initiate and establish communication with the charging station 102. In an embodiment, the charging station 102 is also configured to initiate and establish communication with the vehicle computer system.

The system establishes the communication between the charging station 102 and the charging system upon power turned on to each and connecting (e.g., via wired connection, wireless connection) the charging system to the charging station. The communication established may be a bi-directional communication. The bi-directional communication established may be an autonomous communication. The charging station 102 and the charging system 108 can transmit as well as receive signals and/or data in both directions. In another embodiment, the communication established between the charging station 102 and the charging system 108 is through a wired communication. In yet another embodiment, the communication established between the charging station 102 and the charging system 108 is through wireless communication technology (e.g., Wireless Fidelity (Wi-Fi®), Bluetooth®, Cellular technology, Zigbee® etc.).

In an embodiment, the charging station 102 and the temperature management system coordinate with each other: to extract a state-of-health information of a connected charging system 108; to determine an optimal charging scheme based on allotted time and required charge to optimally charge the connected charging system; to ramp up charging of the connected charging system by the charging station for the first charging time; to monitor the temperature of the battery pack of the connected charging system during a ramp up charging; and to activate the temperature adjustment unit 106 that is capable of cooling the connected charging system 108 if the battery pack temperature is above a threshold temperature during the ramp up charging.

The control unit is configured to receive a message comprising a charging time and a state-of-health information of a battery pack. In an embodiment, the control unit is configured to receive the message comprising the charging time and the state-of-health information of the battery from a vehicle computer system. In yet another embodiment, the control unit is configured to receive the charging time from an external device. The external device may be a personal digital assistant such as a mobile phone, a tablet, a computer, a laptop, a desktop, a smart watch, etc. The external device may be communicatively coupled to the charging station 102 or through an application. The control unit then determines a charging sequence based on the charging time and the state-of-health information. The control unit then determines an amount of power to provide optimal charging to the battery pack during the charging time. The control unit is further configured to communicate a signal to the charger to supply the amount of power determined to the battery pack.

In an embodiment, the charging station 102, upon establishing a connection with the charging system, may extract/receive the charging time and the state-of-health information of the battery pack. The charging time may be provided by the user as an input to the charging station 102 via the vehicle computer system. In an embodiment, the user may provide charging time as the input to the charging station 102 via an external device (e.g., a mobile, a computer, a laptop, a desktop, a tablet, a smart watch, and a personal digital assistant). In an embodiment, the charging time comprises a combination of at least one of a first charging time segment, a second charging time segment, and a third charging time segment. In an embodiment, the user may split the charging time into charging time segments by. In another embodiment, the charging station, via the artificial intelligence unit, automatically splits the charging time into charging time segments based on the state-of-health information and the charging time. In yet another embodiment, the charging station, via the artificial intelligence unit, automatically recommends the charging time segments to the user via the vehicle computer system based on the state-of-health information and the charging time. The user may then approve the recommendation through the vehicle computer system.

The state-of-health information, received by the charging station 102, may comprise a first state-of-health information, a second state-of-health information, and a third state-of-health information. The first state-of-health information may correspond to the first portion of the battery pack. The second state-of-health information may correspond to the second portion of the battery pack. The third state-of-health information may correspond to the third portion of the battery pack.

The charging station 102, via the control unit, determines a charging sequence based on the charging time and the state-of-health information. The charging sequence computed by the charging station 102 may be an optimal charging sequence. The charging sequence may be adapted to charge the battery pack at the maximum voltage for the remaining charging time provided. The charging sequence, computed by the charging station 102, is adapted to provide maximum charging to the battery pack during the charging time (i.e., allotted time) and to prevent damage to the battery pack.

In an embodiment, the charging station 102, via the artificial intelligence unit, recommends the charging sequence based on correlating the charging time and the state-of-health information of the battery pack with a previous history of the battery pack. The artificial intelligence unit may comprise a machine learning algorithm. The artificial intelligence unit analyzes the message comprising the charging time and the state-of-health information of the battery pack. The artificial intelligence unit correlates the charging time and the state-of-health information of the battery pack with a previous history of the battery pack. The artificial intelligence unit then communicates a recommendation of the charging sequence to the control unit based on the analysis.

In an embodiment, the charging sequence comprises a combination of at least one of a level 1 charging, a level 2 charging, and a level 3 charging. In another embodiment, the charging sequence comprises one of a level 1 charging, a level 2 charging, and a level 3 charging. In yet another embodiment, the charging sequence comprises a combination of at least one of a level 1 charging that corresponds to the first portion of the battery pack, a level 2 charging that corresponds to the second portion of the battery pack, and a level 3 charging that corresponds to the third portion of the battery pack. The level 1 charging may be a trickle charging. The level 2 charging may be a regular charging. The level 3 charging may be a fast charging. In yet another embodiment, the charging sequence comprises a combination of at least one of a level 1 charging that corresponds to the first charging time segment, a level 2 charging that corresponds to the second charging time segment, and a level 3 charging that corresponds to the third charging time segment.

In an embodiment, the artificial intelligence unit is configured to analyze the message comprising the charging time and the state-of-health information of the battery pack. The artificial intelligence unit correlates the charging time and the state-of-health information of the battery pack with a previous history of the battery pack. The artificial intelligence unit communicates a recommendation of the charging sequence to the control unit based on the analysis. In another embodiment, the previous history of the battery pack comprises a plurality of charging times of the battery, a plurality of state-of-health information of the battery pack and a plurality of charging sequences that the battery pack has undergone during charging.

In another aspect, a system is described herein. The system comprises the charging station 102. The charging station 102 comprises a control unit. The control unit is configured to establish a bi-directional communication link between the charging station 102 and a vehicle computer system. A bidirectional communication link is also between the user and the charging station 102. In another embodiment, a bidirectional communication link is also there between the charging station 102 and the temperature management system. The control unit of the charging station 102 receives a message comprising an update to at least one of a charging time and a state-of-health information of a battery pack from the vehicle computer system. The charging station 102 determines a charging sequence based on the update to at least one of the charging time and the state-of-health information. The charging station 102 determines an amount of power to provide maximum charge to the battery pack during the charging time. In an embodiment, the charging station 102 is configured to activate the temperature management system to prevent damage to the battery pack and to provide the maximum charging to the battery during the charging time. The temperature of the battery pack is recognized by the temperature prediction unit 104, and the temperature adjustment unit 106 gets activated to bring the temperature within the threshold. The state-of-health information received comprises a first state-of-health information that corresponds to a first portion of the battery pack, a second state-of-health information that corresponds to a second portion of the battery pack, and a third state-of-health information that corresponds to a third portion of the battery pack.

In another embodiment, the charging station further comprises: a charger unit; a charger point; a power distribution network; a temperature management system and an artificial intelligence unit.

In another embodiment, the charging station further comprises: a charger unit; a charger point; a power distribution network; and an artificial intelligence unit. A temperature management system is outside the housing of the charging station.

In yet another embodiment, the artificial intelligence unit is configured to analyze the message comprising the update to the charging time and the state-of-health information of the battery pack. The artificial intelligence unit correlates the update to the charging time, the temperature of the battery pack and the state-of-health information of the battery pack with a previous history of the battery pack. The artificial intelligence unit then communicates a recommendation of the charging sequence to the control unit based on the analysis. In yet another embodiment, the previous history of the battery pack comprises a plurality of charging times of the battery pack, a plurality of state-of-health information of the battery pack and a plurality of charging sequences that the battery pack has undergone during charging.

In yet another embodiment, the charging sequence comprises one of a level 1 charging, a level 2 charging, and a level 3 charging. In yet another embodiment, the charging sequence comprises a combination of at least one of a level 1 charging, a level 2 charging, and a level 3 charging. In yet another embodiment, the charging sequence comprises a combination of at least one of a level 1 charging that corresponds to the first portion of the battery pack, a level 2 charging that corresponds to the second portion of the battery pack, and a level 3 charging that corresponds to the third portion of the battery pack. The level 1 charging may be a trickle charging. The level 2 charging comprises a regular charging. The level 3 charging comprises a fast charging. In an embodiment, the trickle charging comprises an input voltage of 120 volts-208 volts alternating current (AC). The regular charging comprises an input voltage in a range between 208 volts to 280 volts alternating current (AC). The fast charging comprises an input voltage in a range between 400 volts to 900 volts direct current (DC).

In one embodiment, the battery pack comprises a plurality of cells. The first portion of the battery pack may comprise a first plurality of cells among the plurality of cells of the battery pack. The second portion of the battery pack may comprise a second plurality of cells among the plurality of cells of the battery pack. The third portion of the battery pack may comprise a third plurality of cells among the plurality of cells of the battery pack.

In another embodiment, the battery pack comprises at least one of a first battery, a second battery, and a third battery. The first battery may be a primary battery. The second battery may be a secondary battery. The third battery may be a tertiary battery. In this embodiment, the first portion of the battery pack comprises a plurality of cells from a combination of at least one of the first battery, the second battery, and the third battery.

In yet another embodiment, the charging time comprises a combination of at least one of a first charging time segment, a second charging time segment, and a third charging time segment.

In yet another embodiment, the charging station 102 is configured to receive the message comprising the update to the charging time and the state-of-health information of the battery pack from a vehicle computer system. In yet another embodiment, the charging station 102 is configured to receive the message comprising the update to at least one of the charging time and the state-of-health information of the battery pack from the vehicle computer system while the battery pack is connected to the charging station.

In an embodiment, the system further comprises a device to detect a location of the user.

In an embodiment, the user comprises a driver.

In an embodiment, the charging station comprises modules to charge the battery pack in AC mode or DC mode.

In an embodiment, the system is configured for electric vehicles or hybrid vehicles.

In an embodiment, the system is configured for driver or driverless vehicles.

In an embodiment, the system comprises an artificial intelligence unit and a machine learning unit.

In an embodiment, the optimal charging does not always comprise the complete charging of the vehicle.

In an embodiment, the state-of-health information of a connected charging system comprises the prediction of the temperature of the battery pack when the vehicle arrives at a charging station, the traveling state of the vehicle, the number of discharging cycles by the battery pack in a day, and in totality, the charging efficiency of the battery pack.

In an embodiment, the system is further configured to modify the optimal charging scheme by learning about the availability of a user at a location.

In an embodiment, the modification of the optimal charging scheme increases the first charging time of the battery pack.

In an embodiment, the user allots the first charging time.

In an embodiment, the artificial intelligence unit is configured to analyze the message comprising the first charging time and the state-of-health information of the battery pack; correlate the first charging time and the state-of-health information of the battery pack with a previous history of the battery pack; and communicate a recommendation of the optimal charging scheme to the charging station based on the analysis.

In an embodiment, the artificial intelligence unit is configured to determine a second charging time based on the state-of-health information of the battery pack via the vehicle computer system.

In an embodiment, the artificial intelligence unit is configured to recommend the second charging time to a user through the vehicle computer system.

In an embodiment, the artificial intelligence unit is configured to recommend the second charging time to the user through an external device.

In yet another embodiment, the charging station is configured to receive the message comprising the update to the charging time from an external device. In yet another embodiment, the artificial intelligence unit is configured to determine the charging time based on the state-of-health information of the battery pack via the vehicle computer system. In yet another embodiment, the artificial intelligence unit is configured to recommend the charging time to a user through the vehicle computer system. In yet another embodiment, the artificial intelligence unit is configured to recommend the charging time to a user through an external device.

In yet another embodiment, the charging sequence comprises a combination of at least one of a level 1 charging that corresponds to the first charging time segment, a level 2 charging that corresponds to the second charging time segment, and a level 3 charging that corresponds to the third charging time segment.

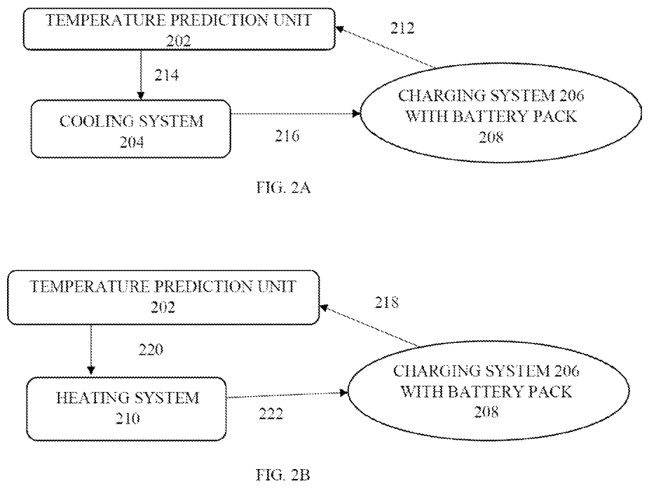

FIG. 2A shows the cooling system in a block and FIG. 2B the heating system in a block.

In an embodiment, the charging system 206 provides the temperature of the battery pack 208 information 212 and 218 to the temperature prediction unit 202. However, if the temperature of the battery pack 208 is above a threshold temperature or not within a range, then after getting information 214 the cooling system 204 can get activate and can provide cooling through a channel 216. Similarly, if the temperature of the battery pack 208 is below a threshold temperature or not within a range, then, after getting information 220 the heating system 210 can get activate and can provide heating through a channel 222.

In one example, the battery pack comprises an individual battery comprising a plurality of cells. The battery pack comprises a first portion, a second portion, and a third portion. The first portion of the battery pack comprises a first plurality of cells among the plurality of cells of the battery pack. The second portion of the battery pack comprises a second plurality of cells among the plurality of cells of the battery pack. The third portion of the battery pack comprises a third plurality of cells among the plurality of cells of the battery pack. The first portion of the battery pack may comprise degraded cells of the battery pack. The second portion of the battery pack may comprise healthy cells of the battery pack. The third portion of the battery pack may comprise moderate degraded cells of the battery pack.

In another example, the battery pack comprises at least one of a first battery, a second battery, and a third battery. The first battery may be a primary battery. The second battery may be a secondary battery. The third battery may be a tertiary battery. Each battery of the battery pack comprises a plurality of cells. The battery pack comprises a first portion, a second portion, and a third portion. The first portion of the battery pack comprises a plurality of first cells from a combination of at least one of the first battery, the second battery, and the third battery. Similarly, the second portion and the third portion comprise the plurality of second cells, and plurality of third cells, respectively, from the combination of at least one of the first battery, the second battery, and the third battery. The first portion of the battery pack may comprise degraded cells of the battery pack. The second portion of the battery pack may comprise healthy cells of the battery pack. The third portion of the battery pack may comprise moderate degraded cells of the battery pack

As an example, assume that the first portion, the second portion, and the third portion of the battery pack may comprise degraded cells, healthy cells, and moderate degraded cells, respectively. The charging station, based on the state-of-health information and the charging time, determines the optimal charging sequence. The optimal charging sequence computed may assign the level 1 charging to the degraded cells, the level 2 charging to the moderate degraded cells and no charging to the degraded cells, respectively.

The control unit is configured to activate the cooling system to prevent damage to the battery pack and to provide the maximum charging to the battery pack during the charging time.

The cooling system 204 may include a chiller assembly that includes a compressor, a condenser, an expansion valve, an evaporator and a fan. During operation of the cooling system 204, the compressor pressurizes and circulates a coolant through a closed loop of the cooling system. In an embodiment, a cooling system 204 including a chiller assembly and a fan arranged to blow an airflow across said chiller assembly to generate a cooling airflow and then direct said cooling airflow toward a portion of a thermal management system located onboard an electric vehicle, wherein cooling system 204 is a part of the charging station housing. In another embodiment, cooling system 204 is separate from the charging station housing and mounted on the electric vehicle at the charging station. The cooling system 204 may also comprise a fan or a cold air blower. In yet another embodiment, the temperature management system also coordinates with the vehicle's air conditioner system to activate it and provide cooling to the battery pack. In an embodiment, the cooling system is housed inside the housing of the charging station.

In a further non-limiting embodiment, the charging station housing includes a vent and the cooling airflow is communicated through the vent to a location external to the housing.

In a further non-limiting embodiment, the chiller assembly includes a heat exchanger, and the fan is configured to communicate airflow across the heat exchanger to generate the cooling airflow.

In a further non-limiting embodiment, the chiller assembly includes a compressor, a first heat exchanger, an expansion valve and a second heat exchanger.

In a further non-limiting embodiment, the first heat exchanger is a condenser and the second heat exchanger is an evaporator.

In a further non-limiting embodiment, a control unit is configured to control operation of the cooling system.

In an embodiment, the control unit communicates a signal to the charger unit to limit the rate at which electric current is added to or drawn from electric batteries to prevent damage. The control unit is also configured to provide maximum charging to the battery pack during the allotted time.

In a further non-limiting embodiment, the control unit is configured to command operation of the cooling system during DC fast charging.

In a further non-limiting embodiment, a charging cord extends from the charging system to a location outside of the housing of the vehicle charging station.

In a further non-limiting embodiment, an external power source power the cooling system.

In another embodiment, the cooling system 204 is a fan which blows air or cold air.

In another embodiment, the cooling system can be any system which brings down the temperature of the battery pack.

In an embodiment, the heating system 210 is a heater or a hot air blower.

In another embodiment, the coolant of the cooling system is capable to act as coolant as well as to pass or blow out the heat, if needed.

In another embodiment, the temperature management system has only a cooling system 204.

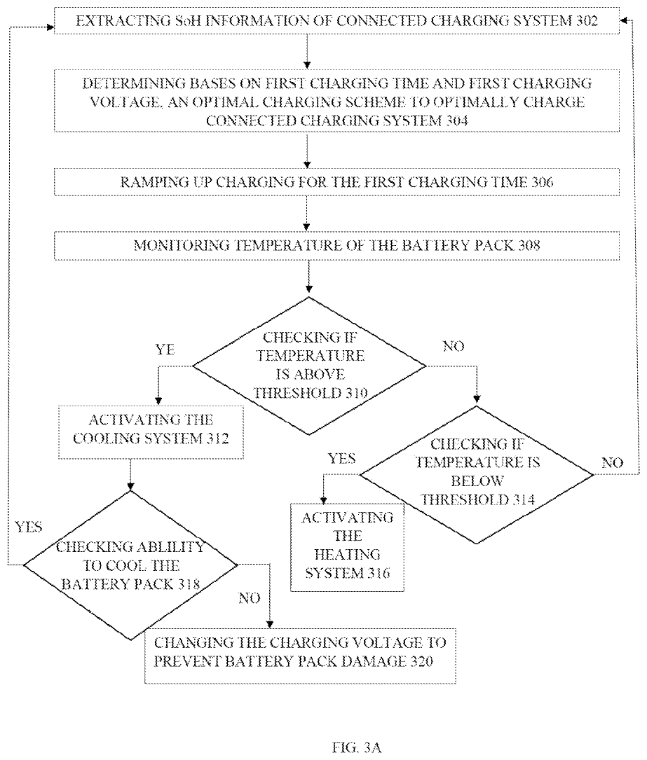

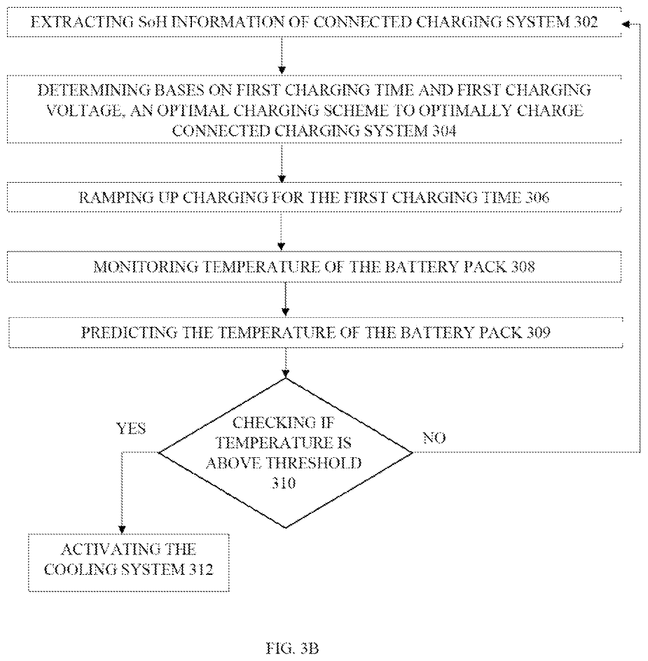

As an example, FIG. 3A shows a flowchart depicting a method to optimally charge a connected charging system by the charging station along with the temperature management system, according to one or more embodiments. The method comprises:
Step 302: extracting, by a charging station, state-of-health (SoH) information of connected charging system;
Step 304: determining, by the charging station, a charging sequence based on the first charging time and first charge voltage, an optimal charging scheme to optimally charge the connected charging system;
Step 306: ramping up charging, by a charging station, for the first charging time;
Step 308: monitoring, by temperature management system, the temperature of the battery pack;
Step 310: checking, if the temperature predicted by the temperature prediction unit is more than the threshold temperature predefined or determined on the basis of the state-of-health information of the battery pack or not;
Step 312: if yes, then cooling system will be activated;
Step 314: if no, then checking, if the temperature predicted by the temperature prediction unit is less than the threshold temperature predefined or determined on the basis of the state-of-health information of the battery pack or not;
Step 316: if yes, then heating system will be activated;
however, if no then again charging station will extract state-of-health (SoH) information of connected charging system;
Step 318: after step 312, again checking will be done, if the temperature adjustment unit is able to cool the battery pack within the threshold temperature predefined or determined on the basis of the state-of-health information of the battery pack;
Step 320: if no, then changing the charging voltage to prevent the battery pack from damage; however, if yes, then again charging station will extract state-of-health (SoH) information of connected charging system.

As another example, FIG. 3B shows a flowchart depicting another method to optimally charge a connected charging system by the charging station along with the temperature management system, according to another embodiments. The method comprises:
Step 302: extracting, by a charging station, state-of-health (SoH) information of connected charging system;
Step 304: determining, by the charging station, a charging sequence based on the first charging time and first charge voltage, an optimal charging scheme to optimally charge the connected charging system;
Step 306: ramping up charging, by a charging station, for the first charging time;
Step 308: monitoring, by temperature management system, the temperature of the battery pack;
Step 309: predicting, by temperature management system, the temperature of the battery pack;
Step 310: checking, if the temperature predicted by the temperature prediction unit is more than the threshold temperature predefined or determined on the basis of the state-of-health information of the battery pack or not.
Step 312: if yes, then cooling system will be activated; otherwise, again charging station will extract state-of-health (SoH) information of connected charging system.

A embodiment relates to a method comprising: extracting, by a charging station comprising a control unit, a state-of-health information of a connected charging system; determining, by a charging station, based on first charging time and required charge, an optimal charging scheme to optimally charge the connected charging system; ramping up charging of the connected charging system by the charging station for the first charging time; monitoring, by the charging station, temperature of battery pack of the connected charging system during a ramp up charging; and activating, by the charging station, the temperature management system that is capable of cooling the connected charging system if temperature reaches above a threshold temperature during the ramping up of charging; and wherein the temperature management system comprises temperature prediction unit and temperature adjustment unit; wherein the temperature adjustment unit comprises a cooling system; wherein the first charging time is allotted by a user.

In an embodiment, the heating system heats the connected charging system when the temperature is below the threshold temperature during the ramping up of charging.

In an embodiment, the user comprises a driver of the vehicle.

In an embodiment, the method comprises altering the optimal charging scheme if the state-of-health information comprises degradation of the battery pack.

In an embodiment, the method further comprises splitting the first charging time into charge intervals based on the charging scheme.

In an embodiment, the method further comprises the information of a location of the user to the charging station.

In an embodiment, the method further comprises altering the charging scheme if the location of the user reveals leeway to remain at the charging station for more time than the first charging time.

In an embodiment, the method comprises altering the charging scheme which leads to a second charging time or a second charging scheme or a second charging voltage.

In an embodiment, the second charging time is more than the first charging time.

In an embodiment, the second charging voltage is less than the charging voltage before alteration of the charging scheme.

In an embodiment, the charging scheme further comprises a level 1 charging, a level 2 charging, a level 3 charging and a combination of three of them.

In an embodiment, the user allocates or predefines the first charging time.

In an embodiment, the state-of-health information, received by the charging station 102, may comprise a first state-of-health information, a second state-of-health information, and a third state-of-health information. The first state-of-health information may correspond to the first portion of the battery pack. The second state-of-health information may correspond to the second portion of the battery pack. The third state-of-health information may correspond to the third portion of the battery pack.

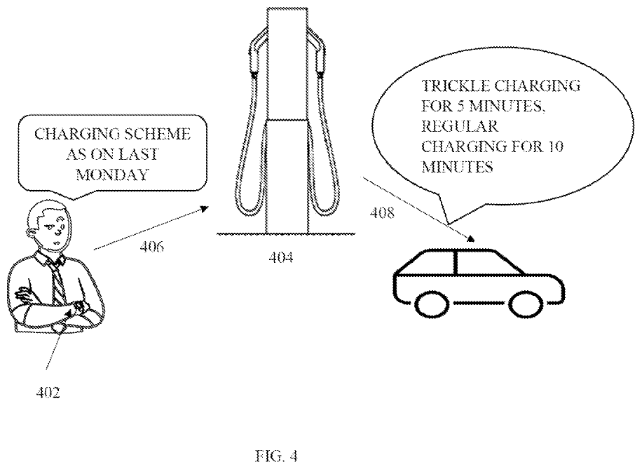

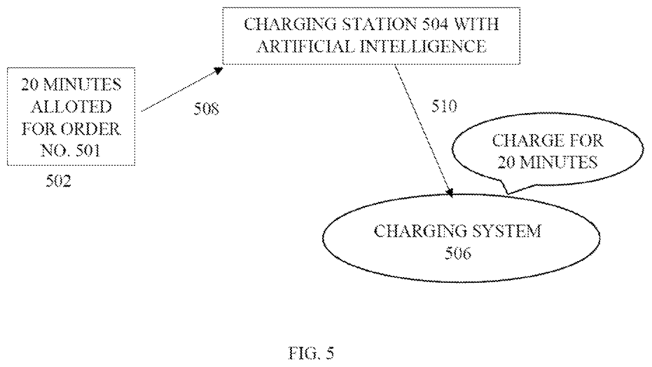

FIG. 4 shows an embodiment of providing instructions to the charging station by the user.

In FIG. 4, the user or the driver is wearing the wrist band 402 and by using the external device (i.e. wrist band), the user provides instructions 406 to the charging station 404. The user is providing instructions to charge the vehicle or EV as per the charging scheme on a particular date, i.e., providing the date itself or the day such as last Monday or last Tuesday and such. Then the charging station 404 communicates with the vehicle to do trickle charging for 5 minutes and regular charging for 10 minutes. Therefore, the user has provided the input to charge the vehicle for 15 minutes and at 120-208 volts for 5 minutes and at 208-280 volts for 10 minutes.

In an embodiment, the external device, the charging station or the vehicle may have a common application in their computer system to work coherently. In an embodiment, the place where the charging station is housed has the same computer application as the external device (e.g. wrist band or smart phone) or the charging station 404 to provide an update of the surroundings.

In an embodiment, the communication between the user, charging station and the vehicle is by wired connection or wireless connection.

In an embodiment, the charging station may receive a message comprising an update to at least one of the charging time, charging voltage and the state-of-health information from the vehicle computer system. In another embodiment, the user may provide the update to at least one of the charging time, charging voltage and the state-of-health information via a user interface (e.g., touch screen) of the vehicle computer system. In another embodiment, the user may provide the update to at least one of the charging time, charging voltage and the state-of-health information using an external device (e.g., mobile phone or smart watch or any band or wrist band) via the vehicle computer system. In another embodiment, the user may provide the update to at least one of the charging time, changing voltage and the state-of-health information directly using an external device (e.g., mobile phone) to the charging station 404. In another embodiment, the user may provide the update to at least one of the charging time, changing voltage and the state-of-health information directly to the charging station 404 and the charging station is configured with natural language processing.

In another embodiment, the user may provide the input as voice input. The charging station via the artificial intelligence unit in the charging station or the vehicle analyzes the voice input. In a commercial charging station, AI in the vehicle computer system analyzes the voice input to send a protocol message to the charging station. The charging station may also comprise a natural language processing unit to analyze and learn the voice input. As an example, consider the user has provided the voice input as “Coffee” via the external device or the vehicle computer system. The vehicle computer system may communicate the voice input to the charging station. The artificial intelligence unit, via the natural language processing unit, analyzes the voice input and determines the time needed for that event (i.e., having a coffee). The artificial intelligence unit provides the determined time as the charging time to the charging station. The artificial intelligence unit compares and matches the voice input with previous voice inputs. Based on the comparison of the voice match and the spoken word or phrase, the artificial intelligence unit determines the charging time. In an embodiment, the natural language processing unit is capable of analyzing and determining the charging time from the voice input provided in a multilingual format.

As another example, consider the user has provided the voice input as “Lunch via the external device or the vehicle computer system. The vehicle computer system may communicate the voice input to the charging station. The artificial intelligence unit, via the natural language processing unit, analyzes the voice input and determines the time needed for that event (i.e., having lunch). The artificial intelligence unit compares and matches the voice input with previous voice inputs. Based on the comparison, the artificial intelligence unit determines the charging time. In an embodiment, the artificial intelligent unit also determines a nearby restaurant by communicating with a database. The artificial intelligence unit in the charging station extracts the list of nearby restaurants from a database and determines the appropriate nearby restaurant based on the location of the electric vehicle and/or the external device. Based on the appropriate restaurant determined, the artificial intelligence unit may modify the determined charging time. For example, in a fast food restaurant, the time for having lunch (e.g., Burger) is 5 minutes, whereas the time for having lunch (e.g., an Indian rice meal) in an Indian Restaurant is 25 minutes. The charging station may determine the charging time based not only on the voice input but also the surrounding circumstances (e.g., location, event, time, availability of services in that location, traffic, etc.) of the user.

In another embodiment, the vehicle computer system determines the charging time based on a travel itinerary of the user. The user, while planning the travel, may allot time for food and beverages as well as for relaxation. The user may prepare the travel itinerary. The charging station, upon establishing a connection with the vehicle computer system, may extract the allotted time from the travel itinerary and receive the allotted time as the charging time from the vehicle computer system. In yet another embodiment, the charging station determines the charging time based on a travel itinerary of the user. The charging station, upon establishing a connection with the vehicle computer system, may extract the travel itinerary and determine the allotted time (e.g., the time for food and beverages and/or relaxation) as the charging time.

In an embodiment, the bi-directional communication link may be established through a wired communication technology. In another embodiment, wireless communication technology establish the bi-directional communication link.

The update to the charging time may be in increments of a predefined time (e.g., +5 minutes, +10 minutes, +15 minutes, +20 minutes, etc.) to the existing charging time. In an embodiment, the update to the charging time may be altogether providing a second charging time. The user may provide the update of the charging time to the charging station 404 via the vehicle computer system. In an embodiment, the user may provide the update of the charging time to the charging station 404 using an external device.

The state-of-health information may be determined by the vehicle computer system while the battery pack is connected to the charging station 404. The vehicle computer system monitors the state-of-health information of the battery pack and provides the update to the state-of-health information to the charging station 404. In an embodiment, the vehicle computer system communicates the update to at least one of the charging time, charging voltage and the state-of-health information of the battery pack to the charging station 404 at a first event. The first event may be a situation where the battery pack is not within the temperature range. The first event may also be a situation where the state-of-health information of the battery pack is critical. The artificial intelligence unit may determine the occurrence of the first event and notify the vehicle computer system and/or the external device. The vehicle computer system, upon receiving the notification, may provide the update to the state-of-health information. The vehicle computer system may determine and provide the update to the charging time to the charging station. In an embodiment, the vehicle computer system determines the update to the charging time based on a distance between a location of the external device (e.g., mobile phone, handset, personal digital assistant (PDA), laptop, tablet, etc.) and the charging station. The charging station 404 upon receiving the update to the charging time and the state-of-health information may modify the charging sequence. The charging station 404 may direct the temperature management system to activate the cooling system at a faster rate.

In an embodiment, the charging station opts for the optimal charging, fast charging, of the vehicle rather than the complete charging of the charging system. Optimal charging in an embodiment refers to the maximum charging, by the charging station along with the temperature management system, while preventing damage, or the least amount of damage, to the battery.

In an embodiment, for example, consider the charging station 404 has initially received the message comprising the charging time and the state-of-health information. The charging station 404 then may compute an optimal charging sequence based on the charging time and the state-of-health information. The charging sequence may comprise different levels of charging corresponding to different portions of the battery pack and different charging time segments. The charging station 404 then determines the voltage to be supplied to charge the electric vehicle as per the charging sequence. The charging station 404 is then capable of receiving an update to at least one of the charging time and the state-of-health information. The vehicle computer system may communicate the update to at least one of the charging time and the state-of-health information. The vehicle computer system may determine the distance between the location of the handset of the user and the charging station. The vehicle computer system then determines the time for the user to reach the charging station based on the distance calculated. The vehicle computer system communicates the time as the update to the charging time.

In an embodiment, the charging station 404 then modifies the charging sequence after receiving an update from the user. In this case, the user may take more time to reach the vehicle or the charging station location than the allotted time for the charging. The charging station notifies the user and asks the user whether to decrease the charging time or increase the charging time or change the charging sequence or scheme. In an embodiment, the charging station may not change the charging sequence from regular charging or trickle charging to fast charging. In another embodiment, the charging station may send an alert to the user via the vehicle computer system or the external device. The alert may comprise a warning message that unplugging the electric vehicle prior to the charging time may damage the battery pack. Further, unplugging the electric vehicle or turning the charging station switch to ‘OFF’ prior to completion of the first charging time may damage the battery pack.

In another embodiment, the second charging time may be greater than the charging time initially provided. The charging station determines the modified charging sequence. In this case, the charging station may change the charging sequence from fast charging to regular charging or trickle charging. The modified charging sequence may provide regular charging to the healthy cells rather than to the healthy and degraded cells of the battery pack to prevent damage to the battery. In an embodiment, the charging station 404 may be equipped with both AC and DC charging of the vehicle.

FIG. 5 shows an embodiment of alteration in the charging scheme. The charging station 504 is equipped with the artificial intelligence unit. The charging station 504 receives an update 508 from the external device that the user may take 20 minutes rather than 15 minutes as initially supposed by the user. Then, the charging station 504 updates the charging scheme via 510 communication to the charging system 506 to charge for 5 more minutes, i.e., 15 minutes+5 minutes, by decreasing the voltage, i.e., from the fast charging to the regular charging or from regular charging to the trickle charging.

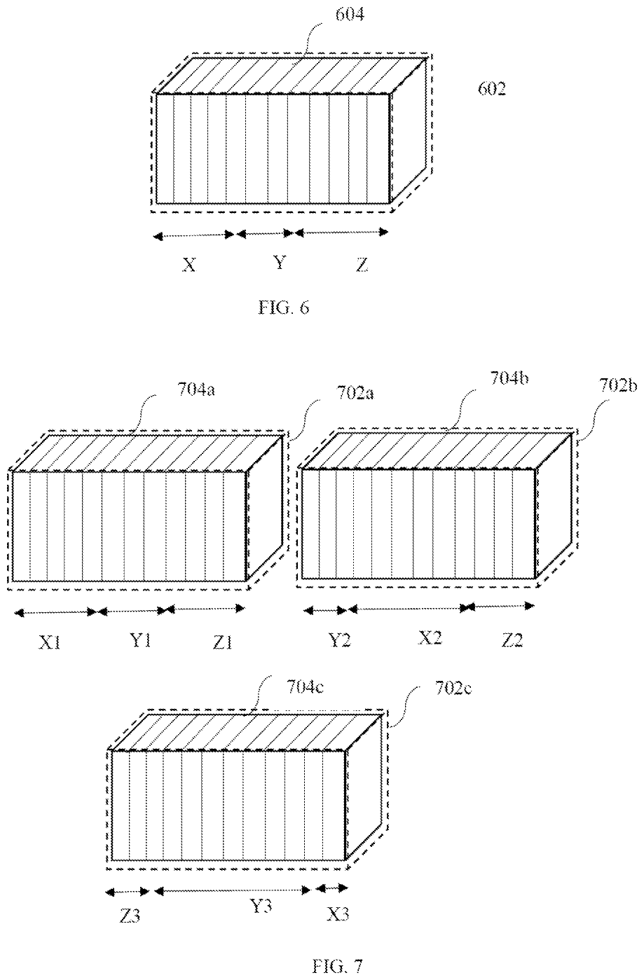

According to an embodiment, FIG. 6 illustrates a battery pack 602 comprising an individual battery. The battery pack 602 herein comprises an individual battery. The battery comprises a plurality of cells 604. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health information. The second portion Y may comprise a second state-of-health information. The third portion Z may comprise a third state-of-health information. In an embodiment, the first portion may refer to a portion of the battery having degraded cells. The second portion may refer to a portion of the battery having healthy cells. The third portion may refer to a portion of the battery having moderate degraded cells.

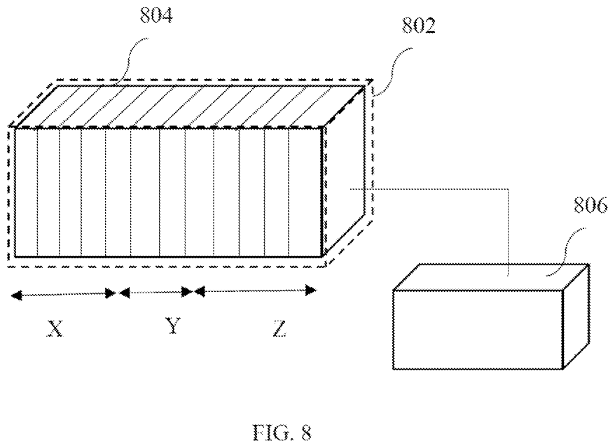

As an example, FIG. 7 illustrates a battery pack comprising a plurality of batteries, according to one or more embodiments. The battery pack herein comprises a first battery 702a, a second battery 702b, and a third battery 702c. The first battery 702a, the second battery 702b, and the third battery 702c may be identical batteries. The first battery 702a, the second battery 702b, and the third battery 702c may be non-identical batteries. In an embodiment, each battery of the battery pack may comprise equal capacity to store and deliver power. In another embodiment, each battery of the battery pack may comprise a different capacity to store and deliver power.

The first battery 702a may comprise a plurality of first cells 704a. The second battery 702b may comprise a plurality of second cells 704b. The third battery 702c may comprise a plurality of third cells 704c. Each battery of the battery pack is connected electrically to get charged by the charging station. The charging station may charge the batteries of the battery pack in a serial configuration, a parallel configuration, or individually.

The charging station may charge at least one of a first portion X, a second portion Y, and a third portion Z of the battery pack. The first portion X of the battery pack refers to degraded cells from each battery of the battery pack (X=X1+X2+X3). The second portion Y of the battery pack refers to healthy cells from each battery of the battery pack (Y=Y1+Y2+Y3). The third portion Z of the battery pack refers to moderate degraded cells from each battery of the battery pack (Z=Z1+Z2+Z3). Healthy cells may be contiguously or non-contiguously located within the same battery. Similarly, degraded and moderate degraded cells may be contiguously or non-contiguously located within the same battery.

The charging station is configured to map the battery pack based on the state-of-health information. In an embodiment, the charging station maps at least one of the degraded cells, the healthy cells, and the moderate degraded cells of the battery pack. The charging station, upon performing mapping the battery pack, determines the charging sequence based on the state-of-health information and the charging time. The charging station may assign the charging sequence to particular portions of the battery pack. In an embodiment, the charging station assigns the charging sequence to only the healthy cells and the moderate degraded cells of the battery pack. The charging station may ignore charging the degraded cells.

As an example, FIG. 8 schematically shows a battery pack comprising a battery pack 802 of one battery and a battery management system 806, according to one or more embodiments. The battery pack 802 comprises a plurality of cells 804. The battery management system 806 may include a microprocessor, microcontroller unit, programmable digital signal processor, or another programmable device. The battery management system 806 may also, or alternatively, comprise an application specific integrated circuit, a programmable gate array or programmable array logic, a programmable logic device or a digital signal processor. Where the battery management system 806 comprises a programmable device such as the microprocessor, microcontroller unit or programmable digital signal processor mentioned above, the processor may also comprise computer executable code which controls the operation of the programmable device. In an embodiment, the battery management system 806 resides within an electric vehicle. The battery management system 806 determines the state-of-health (SoH) of the battery pack and communicates to the charging station via a vehicle computer system.

In an embodiment, the battery management system 806 is configured to: measure a first battery property and a battery temperature of a battery in the electric vehicle; calculating the state-of-health (SoH) of the battery or the determined battery attributes using a predetermined model_{calc} (ii) providing a function f for estimating the cell degradation rate; updating the state-of-health estimated in the previous time step according to:

SoHₑₛₜ←SoHₑₛₜ+f·dt+K·(SoH_{calc}−SoHₑₛₜ)

where K is a gain factor that depends on the operating conditions of the vehicle, and where a reinforcement learning agent modifies K for each time step.

In another embodiment, the battery management system 806 estimates State-of-health (SoH) characteristics of a battery pack in a hybrid vehicle. The estimation of the SoH includes: charging and discharging the battery pack at least one time within an upper region of a State-of-charge (SOC) window. In this case, the battery pack is charged to a first predetermined level in the upper region of the SOC window during a first time period. A first charge current impulse, then charge the battery pack for pushing the SOC level of the battery pack to a level above the first predetermined level and outside the SOC window, during a second time period. An electrical machine, then discharge the battery pack is then to a second predetermined level within the SOC window.

The estimation of the SoH further includes: charging and discharging the battery pack at least one time within a lower region of the SOC window. In this case, the battery pack is charged to a third predetermined level in the SOC window, during a third time period. The battery pack is then discharged by an electrical machine to a fourth predetermined level in the SOC window. A second current impulse, then discharge the battery pack, for pushing the SOC level of the battery pack to a level below the fourth predetermined level and below the SOC window, during a fourth time period.

The estimation of the SoH further includes: calibrating a vehicle's battery pack by the battery management system 806 comprised in the hybrid vehicle by using the reached levels outside the SOC window for determining correct upper and lower edges of the current soc window; and estimating the SoH characteristics of the battery pack during the charge and discharge periods by using the battery management system 806 for determining the condition of the battery pack in comparison to a new and unused battery pack by comparing the current SOC window with a standard SOC window. In an embodiment, the first and third time period is longer than the second and fourth time period, respectively. In another embodiment, the first predetermined level represents a higher voltage than the second predetermined level, and the third predetermined level represents a higher voltage than the fourth predetermined level.

As an example, FIG. 9 illustrates a message received by a charging station, according to one or more embodiments. In an embodiment, the message is similar to HL7 protocol. The message may comprise 0 to 8 bits. The sample message shown in FIG. 9 comprises fields such as vehicle ID, charging time, state-of-health, temperature management, charging type, location of electric vehicle, location of an external device, distance between the external device and charging station, and distance between charging station and EV.

The vehicle ID may be a serial identification number, or a tag associated with the electric vehicle configured to identify and locate the electric vehicle. The charging time may be the allotted time provided for optimally charging the vehicle. The first state-of-health, and the second state-of-health refers to state-of-health information of different portions of the battery pack. The temperature management system informs which temperature adjustment system is needed i.e., whether the cooling system or the heating system is needed or whether the cooling system is working properly to perform temperature management of the battery. Charging types in the charging scheme are regular charging or trickle charging or fat charging. The location of the electric vehicle indicates a current location of the electric vehicle. The location of the external device indicates a current location of the external device, which in turn refers to a location of the user. The charging station, upon receiving a message of the likes in FIG. 9, decodes and extracts the information for charging the electric vehicle. The charging station then may supply voltage according to the information received via the message to optimally charge the electric vehicle for the allotted time.

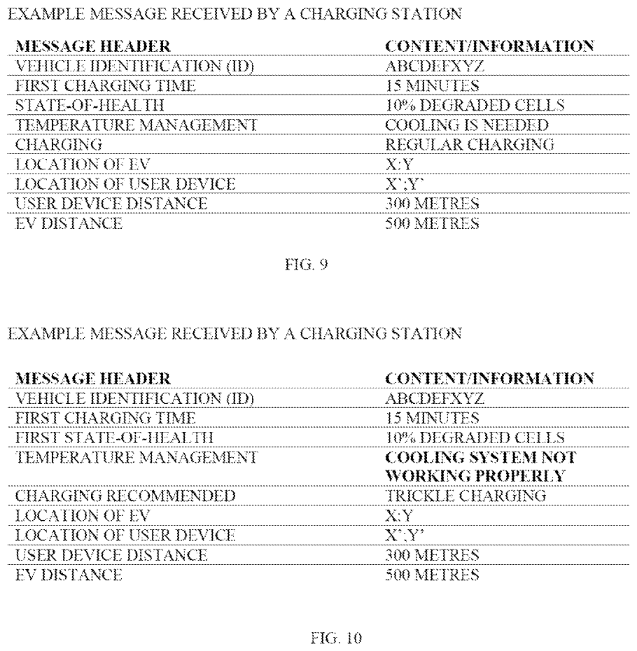

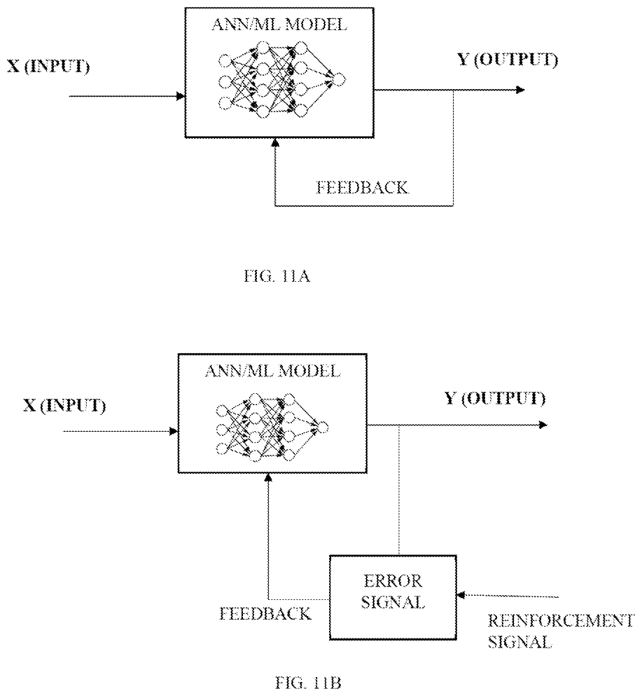

As an example, FIG. 10 illustrates a message received by a charging station, according to one or more embodiments. In an embodiment, the message is similar to HL7 protocol. The message may comprise 0 to 8 bits. The sample message shown in FIG. 10 comprises fields such as vehicle ID, updated charging time, updated first state-of-health, temperature management, charging recommended on the basis of the SoH and temperature management, location of electric vehicle, location of external device, distance between external device and charging station, and distance between charging station and EV.

The vehicle ID may be a serial identification number, or a tag associated with the electric vehicle configured to identify and locate the electric vehicle. The updated charging time may be the allotted time modified for optimally charging the vehicle. The updated state-of-health is communicated. Temperature management is communicated, i.e., cooling system is not working properly. The recommended charging type is communicated, i.e., trickle charging in place of regular charging. The location of the electric vehicle indicates a current location of the electric vehicle. The location of the external device indicates a current location of the external device, which in turn refers to a location of the user. The charging station, upon receiving the message, the likes of FIG. 10, decodes and extracts the information for charging the electric vehicle. The charging station then may modify the supplied power according to the information received via the message to optimally charge the electric vehicle for the allotted time.

In an embodiment, the charging station comprises at least two or more connector interfaces to allow power delivery to EVs with any one or more matching plug types. The charging station system has the ability to deliver both Level 3 DC to DC quick charge and Level 2 AC to DC (up to 70 Amps delivery) as well as Level 1 (regular wall socket when vehicle recharge connector configuration and wall socket location configuration are compatible). The charging station system can charge at least two EVs simultaneously.

The charging station (system) includes a touch-screen device that allows the consumer/user to receive, send, and interact with web-delivered media and content or voice input device to orally dictate the charging scheme to the charging station. An interface is interconnected with the charging station system 100 using Web portal, Small Business Portal, mobile app services and the like.

In an embodiment, the charging station is configured with artificial intelligence and machine learning.

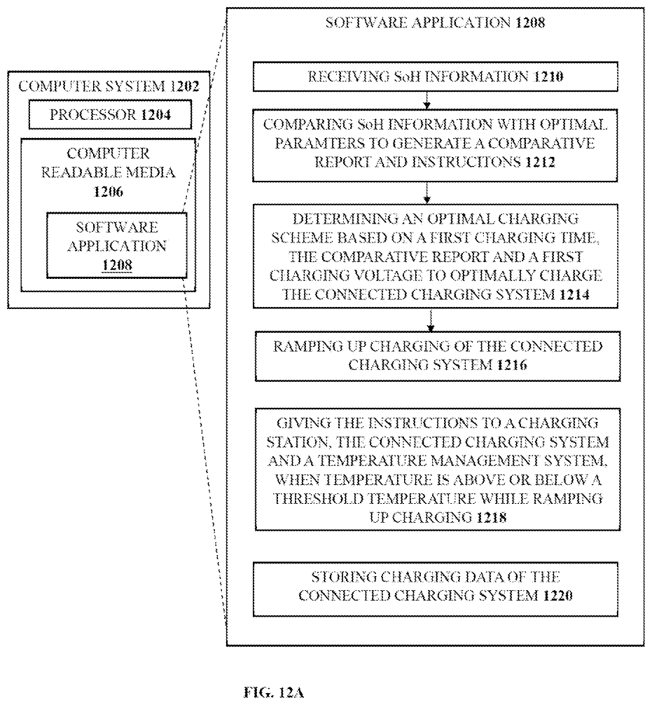

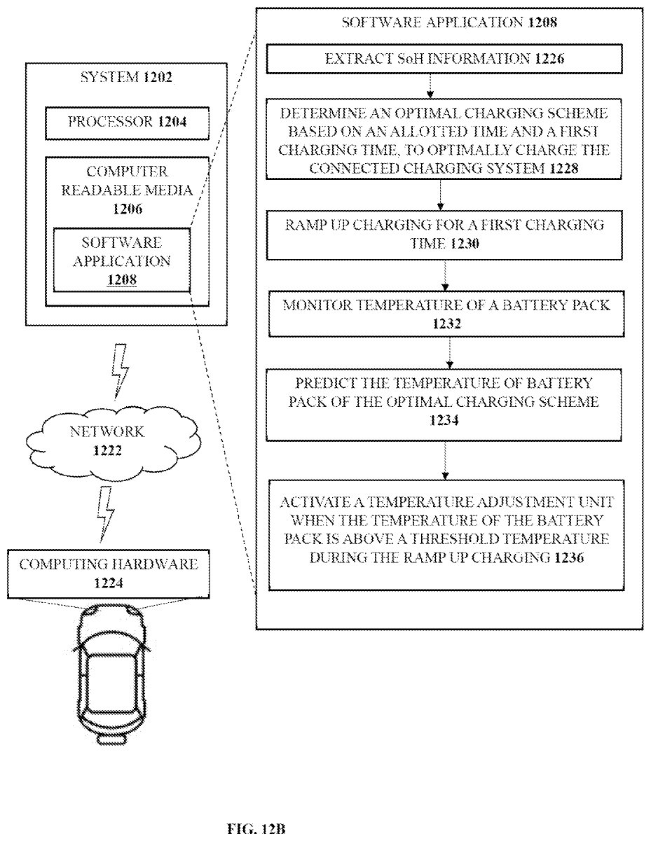

FIG. 11A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data (e.g., message received by the charging station or the charging system), make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, support vector machines. Unsupervised learning comprises logic using at least one of a k-means clustering, a hierarchical clustering, a hidden Markov model, and an apriori algorithm. The output layer may predict or detect or determine at least one of a charge consumption rate, a change in state of health of charging system, a change in temperature of the battery pack, a required charging sequence to maintain a state of charge, a modified charging sequence, an update to charging time, an update to state-of-health information, amount of power etc. based on the input data. The input data may comprise one or more of a charging time, user input (e.g., voice input, text input, etc.), battery consumption rate, environmental factors affecting the battery performance and temperature.

In an embodiment, ANN's may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. The feedback feed back to the model an output from the output layer in a neural network model. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., charging rate, charging pattern, charging sequences, amount of power, etc.) are used that are meant for the model to learn. Afterward, the model is tested using unlabelled data. By using, for example, deep learning and neural networks, the model can then make predictions on whether the desired concept/s (for e.g., charging rate, charging pattern, charging sequences, amount of power, etc.) are in unlabelled images. Each image is given a probability score where higher scores represent a higher level of confidence in the models' predictions. Where a model gives an image a high probability score, it is auto-labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 11B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

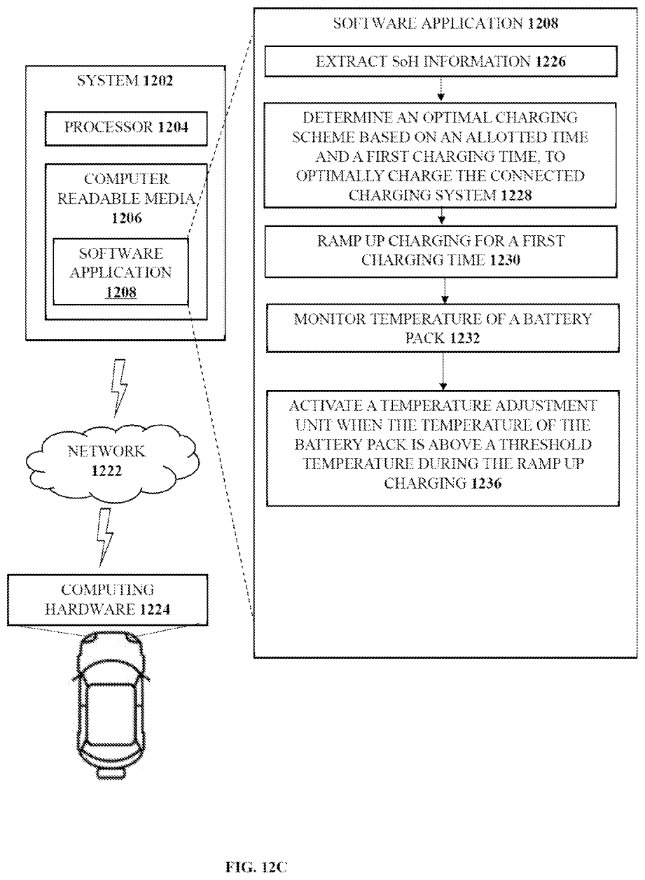

As an example, FIG. 12A shows a computer system 1202 comprising a processor 1204 and a computer readable media 1206 which further comprising software application 1208. This software application performs the following functions:
Step 1210: receiving State of Health (SoH) information from a connected charging system;
Step 1212: comparing SoH information with optimal parameters to generate a comparative report and instructions;
Step 1214: determining an optimal charging scheme based on a first charging time, the comparative report and a first charging voltage to optimally charge the connected charging system;
Step 1216: ramping up charging of the connected charging system;
Step 1218: giving the instructions to a charging station, the connected charging system and a temperature management system, when temperature is above or below a threshold temperature while ramping up charging; and
Step 1220: storing charging data of the connected charging system.

In an embodiment, a non-transitory computer readable medium storing a sequence of instructions, which when executed by a processor comprising: receiving a state-of-health information from a connected charging system; comparing the state-of-health information with optimal parameters to generate a comparative report and instructions; determining an optimal charging scheme based on a first charging time, the comparative report and a first charging voltage to optimally charge the connected charging system; ramping up charging of the connected charging system; giving the instructions to a charging station, the connected charging system and a temperature management system, when temperature is above or below a threshold temperature while ramping up charging; and storing charging data of the connected charging system; wherein the temperature management system comprises a temperature prediction unit and a temperature adjustment unit; wherein the temperature adjustment unit comprises a cooling system; and wherein the non-transitory computer readable medium is a component of the charging station.

In an embodiment, the non-transitory computer readable medium, further comprises giving instructions for altering the optimal charging scheme on the basis of at least a second charging time, a charge interval, and a change in voltage parameters.

In an embodiment, the non-transitory computer readable medium comprising a heating system.

In an embodiment, the non-transitory computer readable medium further comprising giving the instructions to the charging station, the connected charging system and the temperature management system, when the temperature is below the threshold temperature while ramping up charging.

In an embodiment, for the non-transitory computer readable medium, a user allots the first charging time.

In an embodiment, the non-transitory computer readable medium further comprising giving the instructions for altering the optimal charging scheme on basis of at least a second charging time, a charge interval, and change in voltage parameters.

In an embodiment, for the non-transitory computer readable medium, the second charging time is more than the first charging time.

In an embodiment, for the non-transitory computer readable medium, the charge interval comprises the charging at different voltages for different time intervals of the first charging time, and the second charging time.

In an embodiment, the non-transitory computer readable medium, change in voltage parameters comprises low second voltage to that of more first voltage.

In an embodiment, for the non-transitory computer readable medium, the processor is configured to generate a warning message based on a signal.

In an embodiment, for the non-transitory computer readable medium, the signal is based on the optimal charging scheme being altered, on a battery pack temperature is above or below the threshold temperature, on the state-of-health information of a battery pack of the connected charging system.

In an embodiment, the charge intervals allow for the charging at different voltages for different time intervals of the first charging time or second charging time.

In an embodiment, change in voltage parameters comprises a higher first voltage to that of the second low voltage.

In an embodiment, the charging station processor is configured to generate a warning message based on a signal.

In an embodiment, generation of the signal is based on the alteration of the optimal scheme, or the temperature of the battery pack is below or above the threshold temperature, state-of-health of a battery pack of the connected charging system or disconnecting from the charging station.

As an example. FIG. 12B shows a system having software installed in a vehicle, according to one embodiment. According to this embodiment, a system 1202 comprising a processor 1204 and a computer readable media 1206 further comprising a software application 1208. This system 1202 through software application 1208 interacts with a computing hardware 1224 through the network 1222. Further, this software application 1208 performs the following functions:
Step 1226: to extract a state-of-health (SoH) information of a connected charging system;
Step 1228: to determine an optimal charging scheme based on an allotted time and a first charging voltage to optimally charge the connected charging system;
Step 1230: to ramp up charging of the connected charging system by a charging station for a first charging time;
Step 1232: to monitor temperature of a battery pack of the connected charging system;
Step 1234: to predict the temperature of the battery pack of the connected charging system of the optimal charging scheme; and
Step 1236: to activate a temperature adjustment unit when the temperature of the battery pack is above a threshold temperature during the ramp up charging; first charging time and required charge, an optimal charging scheme to optimally charge the connected charging system.

As an example. FIG. 12C shows a system having software installed in a vehicle, according to one embodiment. According to this embodiment, a system 1202 comprising a processor 1204 and a computer readable media 1206 further comprising a software application 1208. This system 1202 through software application 1208 interacts with a computing hardware 1224 through the network 1222. Further, this software application 1208 performs the following functions:
Step 1226: to extract a state-of-health (SoH) information of a connected charging system;
Step 1228: to determine an optimal charging scheme based on an allotted time and a first charging voltage to optimally charge the connected charging system;
Step 1230: to ramp up charging of the connected charging system by a charging station for a first charging time;
Step 1232: to monitor temperature of a battery pack of the connected charging system; and
Step 1236: to activate a temperature adjustment unit when the temperature of the battery pack is above a threshold temperature during the ramp up charging; first charging time and required charge, an optimal charging scheme to optimally charge the connected charging system.

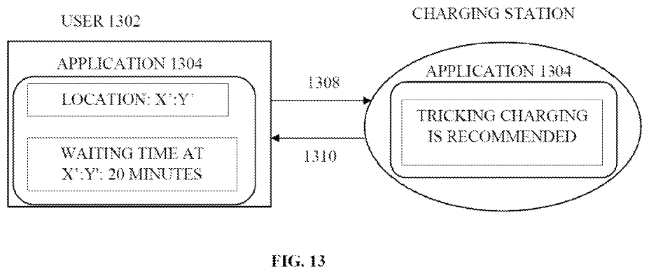

As an example, FIG. 13 shows both user 1302 and charging station 1306 comprising an application 1304. The application 1304 in the user device extract the location of the user as X′:Y′ and waiting time of the user at X′:Y′ as 20 minutes and sends the information about the user 1308 to the charging station 1306. Similarly, application 1304 at the charging station sends the information 1310 that trickling charging is recommended to the user.

An embodiment relates to a device comprising: an application configured to:
extract location of a user;
extract waiting time of the user at the location;
send information about the user to a charging station;
receive information from the charging station;
wherein the user and the charging station both comprise the application.

An embodiment relates to a system, comprising:
set of instructions executable by a computing hardware and stored in a non-transitory storage medium that, when executed, cause the computing hardware to implement operations comprising,
to extract a state-of-health information of a connected charging system;
to determine an optimal charging scheme based on an allotted time and a first charging voltage to
to ramp up charging of the connected charging system by a charging station for a first charging time;
to monitor temperature of a battery pack of the connected charging system;
to predict the temperature of the battery pack of the connected charging system of the optimal charging scheme; and
to activate a temperature adjustment unit when the temperature of the battery pack is above a threshold temperature during the ramp up charging; and
wherein the temperature adjustment unit cools the connected charging system; and
wherein the system is configured for a software application to be installed, via a software installation package provided over a computer network, onto the computing hardware associated with a vehicle.

An embodiment relates to a system, comprising:
set of instructions executable by a computing hardware and stored in a non-transitory storage medium that, when executed, cause the computing hardware to implement operations comprising, to extract a state-of-health information of a connected charging system;
to determine an optimal charging scheme based on allotted time and first charging voltage to optimally charge the connected charging system;
to ramp up charging of the connected charging system by a charging station for a first charging time;
to monitor temperature of a battery pack of the connected charging system; and
to activate a temperature adjustment unit when the temperature of the battery pack is above a threshold temperature during the ramp up charging; and
wherein the temperature adjustment unit cools the connected charging system; and
wherein the system is configured for a software application to be installed, via a software installation package provided over a computer network, onto the computing hardware associated with a vehicle.

An embodiment relates to a system comprising a charging station comprising a control unit; and a temperature management system;
wherein the temperature management system comprises a temperature prediction unit and a temperature adjustment unit;
wherein the charging station and the temperature management system coordinate with each other:
to extract a state-of-health information of a connected charging system;
to determine an optimal charging scheme based on allotted time and first charging voltage to optimally charge the connected charging system;
to ramp up charging of the connected charging system by the charging station for a first charging time;
to monitor temperature of a battery pack of the connected charging system; and
to activate the temperature adjustment unit when the temperature of the battery pack is above a threshold temperature during the ramp up charging; and
wherein the temperature adjustment unit cools the connected charging system.

An embodiment relates to a method comprising:
extracting, by a charging station comprising a control unit, a state-of-health information of a connected charging system;
determining, by a charging station based on first charging time and first charging voltage, an optimal charging scheme to optimally charge the connected charging system;
ramping up charging of the connected charging system by the charging station for the first charging time;
monitoring, by temperature prediction unit temperature of battery pack of the connected charging system;
activating, a temperature adjustment unit, when the temperature of the battery pack of the connected charging system is above a threshold temperature during the ramping up of charging; and
wherein a temperature management system comprises the temperature prediction unit and the temperature adjustment unit;
wherein the temperature adjustment unit comprises a cooling system;
wherein a user allots the first charging time; and
wherein the temperature adjustment unit cools the connected charging system.

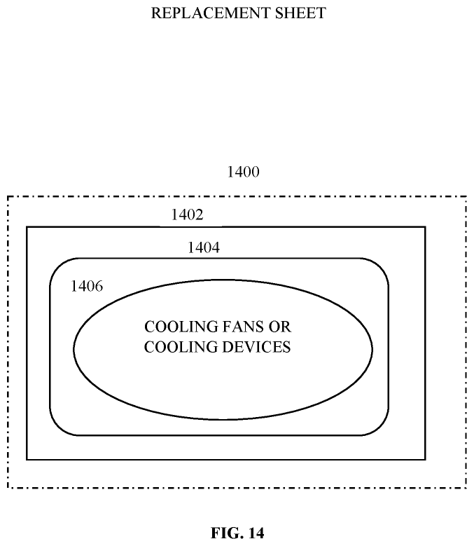

As an example, FIG. 14 shows a system 1400 comprising a charging station 1402 comprising a temperature control system 1404. Temperature control system 1404 further comprising a cooling system 1406 which may be cooling fans or any other cooling devices.

An embodiment relates to a system comprising a charging station comprising a temperature control system comprises a cooling system capable of cooling a connected battery;
wherein the cooling system is configured with cooling fans or devices that are configured to blow cool air.

In an embodiment, the temperature control system activate the cooling system to lower the temperature of the connected battery when the temperature of the connected battery reaches a threshold or impacts charging to continue charging using an optimal charging scheme without any alternation.

In an embodiment, the system alter an optimal charging scheme to prevent damage to the connected battery when the cooling system is not effective due to external conditions.

In an embodiment, the system is an optimal charging system.

In an embodiment, the system is configured to determine an optimal charging scheme based on allotted time and required charge to optimally charge the connected battery.

In an embodiment, the system is configured to receive allotted time to charge, establish connection with vehicle to extract additional information; wherein the additional information comprises state of health (SOH) of battery, temperature of the battery, impact of charging at current temperatures.

In an embodiment, the system uses the additional information to optimally charge the connected battery for the allotted time, including controlling the temperature of the battery using one or more cooling systems.

An embodiment relates to a method of installing a software, wherein the software is configured to:
extract a state-of-health information of a connected charging system;
determine, based on first charging time and required charge, a charging scheme to optimally charge the connected charging system;
give instructions to ramp up charging of the connected charging system for the first charging time;
give instructions to monitor the temperature of the battery pack of the connected charging system during ramp up charging; and
give instructions to activate a temperature management system that is capable of cooling the connected charging system if temperature reaches above a threshold temperature during the ramping up of charging; and
wherein the temperature management system comprises a temperature prediction unit and a temperature adjustment unit;
wherein the temperature adjustment unit comprises a cooling system;
wherein a user allots the first charging time.

In an embodiment, the voltage may remain constant through the first charging time or break down into different charging levels, E.g., trickle charge for 40% allotted time, regular charge at 40% allotted time and then fast charge at 20% allotted time. In an embodiment, the order of different charging levels can be any order.

In an embodiment, if the user has not provided the type of charging e.g. fast charging or optimal charging or trickle charging, then the system is going to use a default charging scheme to optimize the charging based on SoH of the battery pack, based on checking the weather, how many times there was fast charging, the trip or planned itinerary, the current trip route or routing.

In an embodiment, there is a communication link between the user and the charging station system to transcend either a text message or a specific signal. For example, after the allotted time, the charging station can send messages to the user like: Do you want me to continue charging? Or do you want me to stop charging? and then can provide all the information about the battery or the charging scheme. On that basis, the user can decide to continue or discontinue charging. In an embodiment, once that information is provided to the charging station the charging station knows how to communicate with the user; or the communication of the charging station and the use could be through the server in the charging station housing. If a charging system does not have a server, the user can ask, or operate, the charging station directly when the charging system is connected.

In an embodiment, the heating system is not a part of the temperature management system of the charging station.

In an embodiment, the charging station is configured to do battery mapping based on health of the battery and accordingly plan a charging scheme for the individual batteries.

In an embodiment, the vehicle assists with the cooling of the battery, e.g., after receiving information from the charging station that the battery portion is heating up, the vehicle can turn on its vehicular Air Conditioner, and direct the air conditioner air flow to the battery. Therefore, either the vehicle can cool the battery down after receiving information from the charging station, or the charging station configured with a cooling system that is external to the vehicle, can blow air to and around the battery to cool it down.

This foregoing disclosure provides illustration and description but is not intended to be exhaustive or to limit the implementations to the precise form disclosed. Modifications and variations are possible in light of the above disclosure or may be acquired from practice of the implementations.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All variations which come within the meaning and range of equivalency of the claims are to be embraced within their scope.

In addition, it will be appreciated that the various operations, processes, and methods disclosed herein may be embodied in a non-transitory machine-readable medium and/or a system. Accordingly, the specification and drawings are to be regarded in an illustrative rather than a restrictive sense.

1-81. (canceled)

82. A system comprising:
a charging station comprising a control unit; and a temperature management system;
wherein the temperature management system comprises a temperature prediction unit and a temperature adjustment unit;
wherein the charging station and the temperature management system coordinate with each other:
to extract a state-of-health information of a connected charging system;
to determine an optimal charging scheme based on allotted time and first charging voltage to optimally charge the connected charging system;
to ramp up charging of the connected charging system by the charging station for a first charging time;
to monitor temperature of a battery pack of the connected charging system;
to predict the temperature of the battery pack of the connected charging system of the optimal charging scheme; and
to activate the temperature adjustment unit when the temperature of the battery pack is above a threshold temperature during the ramp up charging; and
wherein the temperature adjustment unit cools the connected charging system.

83. The system of claim 82, wherein the temperature adjustment unit comprises a cooling system.

84. The system of claim 82, wherein the temperature prediction unit is configured to monitor and predict the temperature of the battery pack of the connected charging system.

85. The system of claim 82, further configured to alter a charging scheme if a temperature is above a set threshold temperature to prevent damage to battery pack.

86. The system of claim 85, wherein the charging scheme comprises a charging time, charging voltage, and voltage intervals; and wherein a user defines the charging scheme.

87. The system of claim 85, wherein the charging scheme further comprises a level 1 charging, a level 2 charging, a level 3 charging and a combination of three of them.

88. The system of claim 87, wherein the level 1 charging comprises a trickle charging.

89. The system of claim 87, wherein the level 2 charging comprises a regular charging.

90. The system of claim 87, wherein the level 3 charging comprises a fast charging.

91. The system of claim 88, wherein the trickle charging comprises an input voltage in a range between 120 volts to 208 volts alternating current (AC).

92. The system of claim 89, wherein the regular charging comprises an input voltage in a range between 208 volts to 280 volts alternating current (AC).

93. The system of claim 90, wherein the fast charging comprises an input voltage in a range between 400 volts to 900-volts direct current (DC).

94. A method comprising:
extracting, by a charging station comprising a control unit, a state-of-health information of a connected charging system;
determining, by a charging station based on a first charging time and first charging voltage, an optimal charging scheme to optimally charge the connected charging system;
ramping up charging of the connected charging system by the charging station for the first charging time;
monitoring, by a temperature prediction unit, a temperature of a battery pack of the connected charging system;
predicting, by the temperature prediction unit, the temperature of the battery pack of the connected charging system of the optimal charging scheme; and
activating, a temperature adjustment unit, when the temperature of the battery pack of the connected charging system is above a threshold temperature during the ramping up of charging; and
wherein a temperature management system comprises the temperature prediction unit and the temperature adjustment unit;
wherein the temperature adjustment unit comprises a cooling system; wherein a user allots the first charging; and
wherein the temperature adjustment unit cools the connected charging system.

95. The method of claim 94, wherein the user comprises a driver of a vehicle.

96. The method of claim 94, further comprising splitting the first charging time into a charge interval based on the optimal charging scheme.

97. The method of claim 94, further comprising information of a location of the user to the charging station.

98. A non-transitory computer readable medium storing a sequence of instructions, which when executed by a processor comprising:
receiving a state-of-health information from a connected charging system;
comparing the state-of-health information with optimal parameters to generate a comparative report and instructions;
determining an optimal charging scheme based on a first charging time, the comparative report and a first charging voltage to optimally charge the connected charging system;
ramping up charging of the connected charging system;
giving the instructions to a charging station, the connected charging system and a temperature management system, when temperature is above or below a threshold temperature while ramping up charging; and
storing charging data of the connected charging system;
wherein the temperature management system comprises a temperature prediction unit and a temperature adjustment unit;
wherein the temperature adjustment unit comprises a cooling system; and
wherein the non-transitory computer readable medium is a component of the charging station.

99. The non-transitory computer readable medium of claim 98, further comprising giving the instructions for altering the optimal charging scheme on basis of at least a second charging time, a charge interval, and change in voltage parameters.

100. The non-transitory computer readable medium of claim 98, the processor is configured to generate a warning message based on a signal.

101. The non-transitory computer readable medium of claim 100, wherein the signal is based on the optimal charging scheme being altered, on a battery pack temperature is outside the threshold temperature, on the state-of-health information of a battery pack of the connected charging system.
